(19) United States
(12) Patent Application Publication
(10) Pub. No.: US 2025/0218040 A1
(43) Pub. Date: Jul. 3, 2025

(54) CALIBRATION OF DEPTH MAP GENERATING SYSTEM

(71) Applicant: ams-OSRAM Asia Pacific Pte. Ltd., Singapore (SG)

(72) Inventor: Jérôme MAYE, MARTIGNY (CH)

(21) Appl. No.: 18/851,699

(22) PCT Filed: Mar. 17, 2023
(86) PCT No.: PCT/SG2023/050173

§ 371 Date: Sep. 27, 2024

(30) Foreign Application Priority Data
Apr. 5, 2022 (DE) 10 2022 203 367.1

(51) Int. Cl. G06T 7/80; G06T 7/521

(52) U.S. Cl. CPC G06T 7/80; G06T 7/521; G06T 2207/10028

(57) ABSTRACT

Disclosed herein is a calibration method for a depth map generating system. A projection system and imaging system thereof projects an array of dots onto a planar surface located at a first known distance, obtains a first image of the projected dots, and determines a first set of three-dimensional positions of the projected dots at the planar surface; projects an array of dots onto a planar surface located at a second known distance, obtains a second image of the projected dots, and determines a second set of three-dimensional positions of the projected dots at the planar surface. Projected dots of the first set are associated with projected dots of the second set. Convergence of the lines is used to calculate a center position. The center position is used with the projected dots and intrinsic properties to predict the spatial position of dots of light for different distances of an object.

### TECHNICAL FIELD OF THE DISCLOSURE

The disclosure relates to a method of calibrating a depth map generating system, and to a depth map generating system.

### BACKGROUND OF THE DISCLOSURE

Depth map generation is used in a variety of applications. For example, a smartphone may be provided with a depth map generating system. The depth map generating system may be used to generate a depth map of a user's head, or of an environment around a user. Depth map generation may be via a time-of-flight system in which pulses of light are emitted at known times, and the elapsed time until the pulses of light are detected is measured. The time between emission of a pulse and detection of the pulse indicates the distance travelled by the pulse. The distance of an object which has reflected (or scattered) the pulse can be calculated. The pulses may be infrared radiation, which may be referred to as light in this document for ease of terminology.

In depth map generation, a field of view may be illuminated using a so-called flood projector, and the time-of-flight of light reflected from objects in the field of view may be measured. The measurements are then used to generate a depth map. A disadvantage of flood illumination is that it uses a lot of power and the resulting depth map may contain a lot of noise. To address these issues, a depth map may be generated using an array of areas of light (which may be referred to as dots) in the field of view. The time-of-flight for each dot may be measured, and these may be combined together to generate a depth map. This uses less power and may provide a depth map with less noise.

A problem which arises when generating a depth map using an array of dots of light is that the spatial positions of the dots of light, as seen by an imaging system, will change depending upon the distance from the system. This is due to parallax arising from the fact that the imaging system is not coaxial with the sources of the pulses of light. A separation between the imaging system and the source may be unknown due to manufacturing tolerances. As a result, the size of the parallax and its effect may be different for each depth map generating system. This may cause undesirable distortion of a depth map generated using the depth map generating system.

It is an aim of the present disclosure to address the above problem.

### SUMMARY

In general, this disclosure proposes to overcome the above problem by using a calibration which calculates three-dimensional positions of dots of light at for least two distances from a source, calculates lines which pass through associated dots of light, uses these to calculate an optical center of the source, and then calculates three-dimensional rays which extend outwardly from the optical center of the source (the three-dimensional rays corresponding with light beams which are emitted from the source).

According to a first aspect of the invention there is provided a method of calibrating a depth map generating system comprising a projection system and an imaging system, the method comprising: using the projection system to project an array of dots onto a planar surface located at a first known distance from the projection system, obtaining a first image of the projected dots using the imaging system, and determining a first set of three-dimensional positions of the projected dots at the planar surface; using the projection system to project an array of dots onto a planar surface located at a second known distance from the projection system, obtaining a second image of the projected dots using the imaging system, and determining a second set of three-dimensional positions of the projected dots at the planar surface; associating projected dots of the first set of three-dimensional positions with projected dots of the second set of three-dimensional positions, and using convergence of the lines to calculate a position of the center of the projection system; and using the calculated center position of the projection system, together with the projected dots and intrinsic properties of the imaging system, to predict the spatial position of dots of light for different distances of an object from the imaging system.

Advantageously, the method may allow calibration of the depth map generating system to be achieved more quickly and using less space than known methods.

Associating the projected dots of the first set of three-dimensional positions with the projected dots of the second set of three-dimensional positions may comprise: calculating lines which extend from an estimated center of the projection system through the first set of three-dimensional positions of the projected dots, determining intersection points of these lines with the plane of the second set of three-dimensional positions of the projected dots, and associating the intersection points with the dots of the second set of the projected dots.

A distance between the intersection point of a line and a dot of the second set of dots may be calculated, and if that distance exceeds a threshold value then the dot may be rejected and not associated with a dot of the first set of dots.

Centers of dots of the first image of the projected dots may be calculated using quadratic interpolation.

Calculating the position of the center of the projection system using the convergence of the lines may include using a least-squares fit.

Calculating the position of the center of the projection system using the convergence of the lines may include calculating the position of the center, determining outlier lines and then recalculating the position of the center without including the outlier lines.

The method may further comprise measuring intrinsic properties of the imaging system.

According to a second aspect of the invention, there is provided a method of generating a depth map comprising using a projection system and an imaging system which have been calibrated according to the first aspect of the invention, determining time-of-flight for beams of light emitted from the projection system, and using calculated three-dimensional rays which extend from the imaging system outwards to allocate three-dimensional positions for dots of light based upon times of flight.

According to a third aspect of the invention, there is provided a depth map generating system comprising a projection system and an imaging system, and a controller, the controller being configured to: cause the projection system to project an array of dots onto a planar surface located at a first known distance from the projection system, to obtain a first image of the projected dots using the imaging system, and to determine a first set of three-dimensional positions of the projected dots at the planar surface; cause the projection system to project an array of dots onto a planar surface located at a second known distance from the projection system, to obtain a second image of the projected dots using the imaging system, and to determine a second set of three-dimensional positions of the projected dots at the planar surface; associate projected dots of the first set of three-dimensional positions with projected dots of the second set of three-dimensional positions, and use convergence of the lines to calculate a position of the center of the projection system; and using the calculated center position of the projection system, together with the projected dots and intrinsic properties of the imaging system, predict the spatial position of dots of light for different distances of an object from the imaging system.

Advantageously, the depth map generating system may be able to achieve calibration more quickly and using less space than known methods.

Associating the projected dots of the first set of three-dimensional positions with the projected dots of the second set of three-dimensional positions may comprise: calculating lines which extend from an estimated center of the projection system through the first set of three-dimensional positions of the projected dots, determining intersection points of these lines with the plane of the second set of three-dimensional positions of the projected dots, and associating the intersection points with the dots of the second set of the projected dots.

A distance between the intersection point of a line and a dot of the second set of dots may be calculated, and if that distance exceeds a threshold value then the dot is rejected and is not associated with a dot of the first set of dots.

Centers of dots of the first image of the projected dots may be calculated using quadratic interpolation.

Calculating the position of the center of the projection system using the convergence of the lines may include using a least-squares fit.

Calculating the position of the center of the projection system using the convergence of the lines may include calculating the position of the center, determining outlier lines and then recalculating the position of the center without including the outlier lines.

Intrinsic properties of the imaging system may be stored in a memory.

The controller may be further configured to determine time-of-flight for beams of light emitted from the projection system, and using calculated three-dimensional rays which extend from the imaging system outwards to allocate three-dimensional positions for dots of light based upon times of flight.

### BRIEF DESCRIPTION OF THE PREFERRED EMBODIMENTS

Some embodiments of the disclosure will now be described by way of example only and with reference to the accompanying drawings, in which:

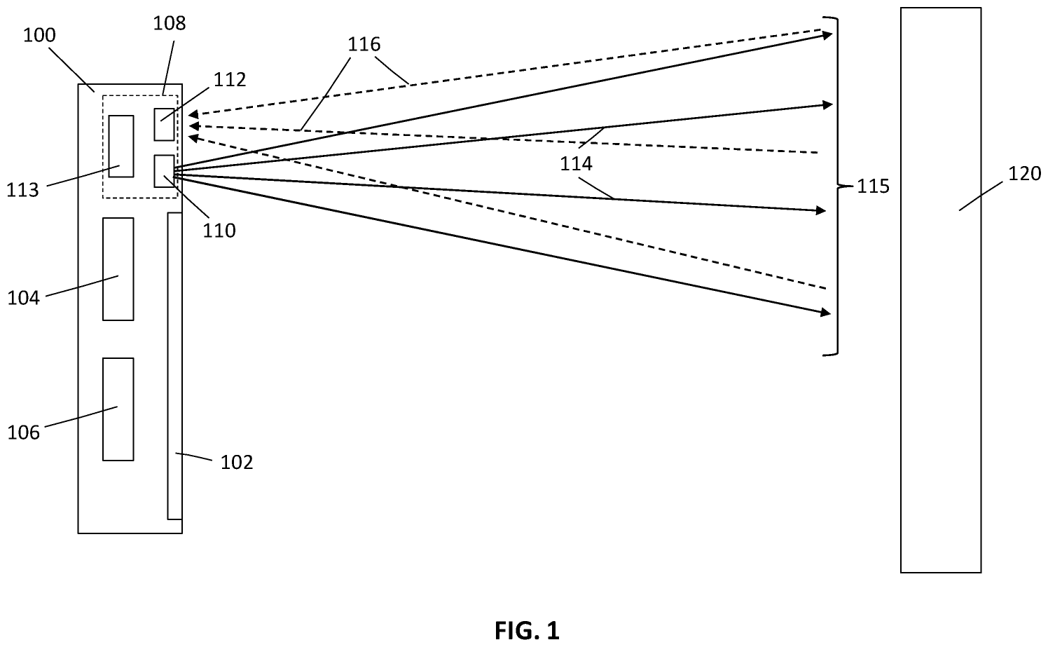

FIG. 1 schematically depicts in cross-section a smartphone which includes a depth map generating system according to an embodiment of the disclosure;

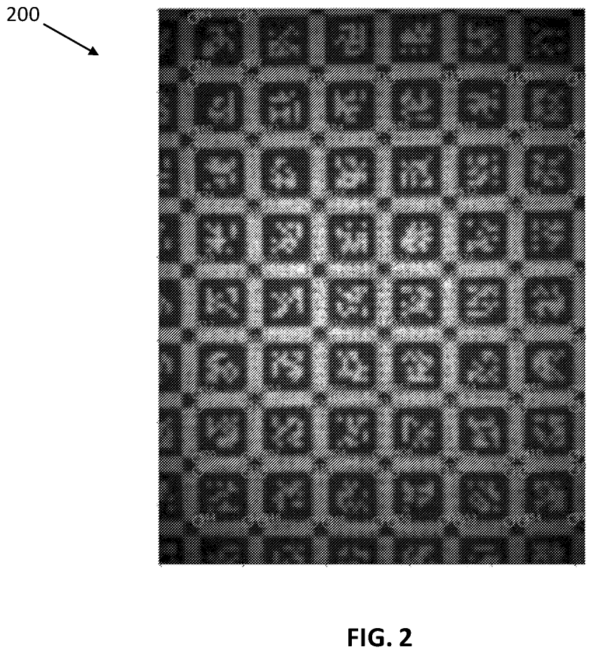

FIG. 2 depicts a calibration pattern used to calibrate an imaging system of the depth map generating system;

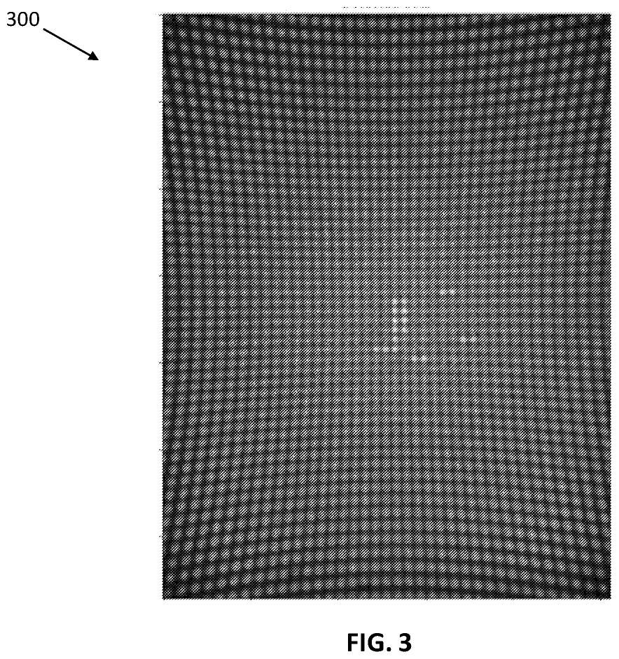

FIG. 3 depicts dots of light which have been detected by an imaging sensor of the depth map generating system, and depicts calculated centers of those dots;

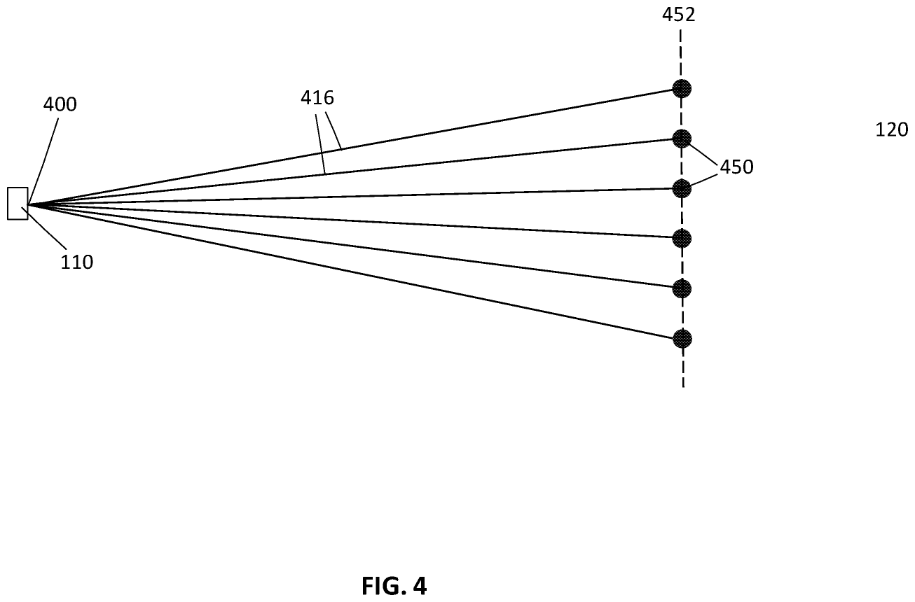

FIG. 4 schematically depicts calculation of lines which extend from an estimated center of a projection system of the depth map generating system, and which pass through a calculated first three-dimensional array of dots;

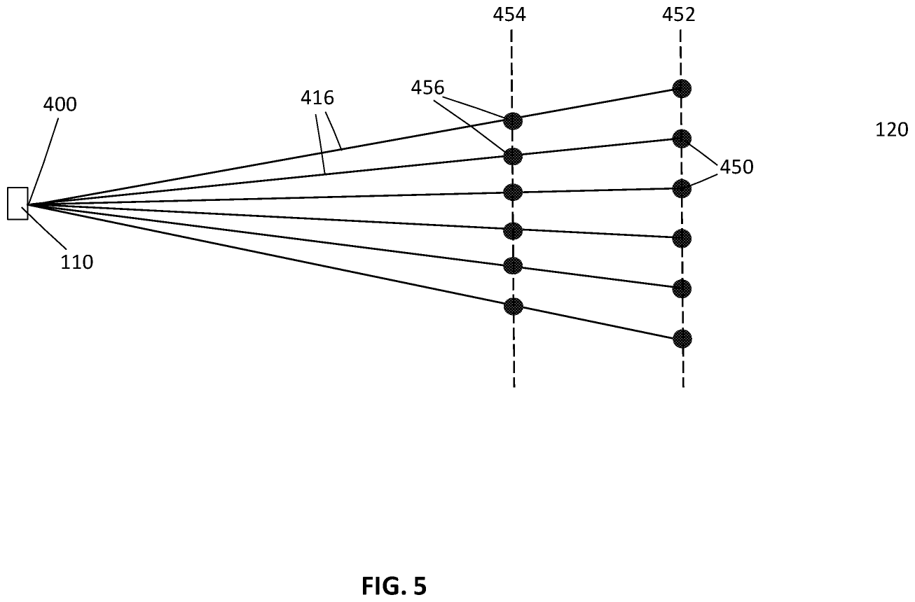

FIG. 5 schematically depicts intersection of the calculated lines with a plane of a calculated second three-dimensional array of dots; and

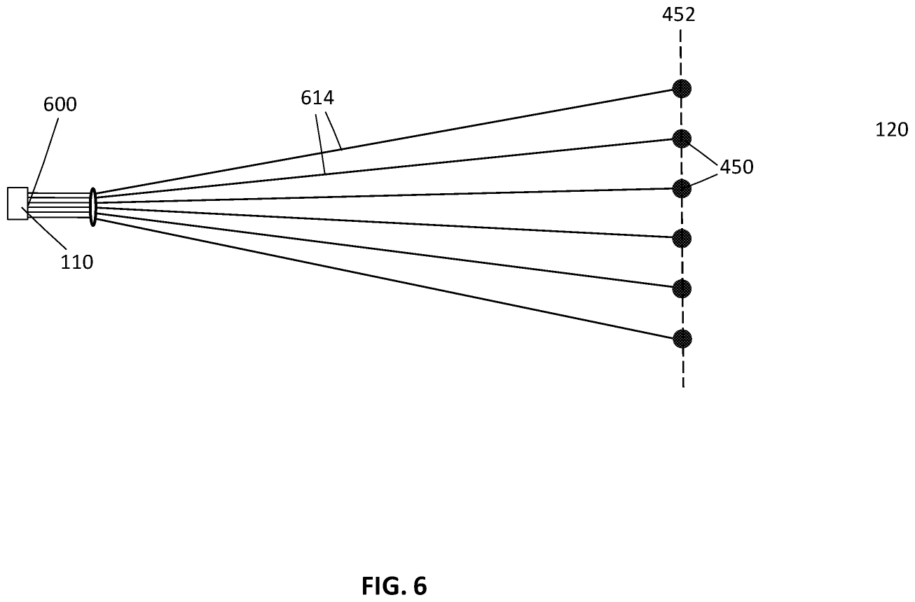

FIG. 6 schematically depicts calculating a set of reference dots in an image plane of the imaging sensor of the depth map generating system.

### DETAILED DESCRIPTION OF THE PREFERRED EMBODIMENTS

Generally speaking, the disclosure provides a depth map generating system which is calibrated via a novel method. The method includes calculating three-dimensional positions of dots of arrays at two different known distances from the depth map generating system, using these to calculate an optical center of a projection system of the depth map generating system, and then calculating three-dimensional rays which extend from the projection system.

Some examples of the solution are given in the accompanying Figures.

FIG. 1 schematically depicts a smartphone 100 comprising a display 102, a processor 104 and a memory 106. The smartphone 100 further comprises a depth map generating system 108 configured to generate a depth map of a field of view. The system 108 uses a method according to an embodiment of the invention. The system 108 comprises a projection system 110, an imaging system 112 and a controller 113. In some embodiments the controller 113 may form part of the processor 104.

The projection system 110 is configured to emit an array of discrete radiation beams 114. The array of discrete radiation beams 114 may for example be infrared radiation beams. Other wavelengths of radiation may be emitted, although infrared may be preferred because it is not seen by users. The term “light” is used in this document for brevity and encompasses infrared radiation and radiation of other wavelengths.

The plurality of discrete light beams may illuminate a field of view 115. The projection system 110 may comprise a plurality of light emitting elements such as, for example, laser diodes. The projection system 110 may comprise an array of vertical cavity surface emitting lasers (VCSELs). The projection system 110 may further comprise optics which are configured to condition the plurality of discrete light beams. The conditioning may for example form an array of discrete areas of light (which may be referred to as dots), the dots having positions which do not vary with distance from the projection system 110 over an operating range of the system 108 (when viewed from the projection system). The optics may comprise one or more micro-lens arrays, a diffractive optical element, or other optics.

The imaging system 112 comprises an imaging sensor and associated optics. The imaging sensor comprises a two-dimensional array of sensing elements. The imaging sensor may comprise various light sensitive technologies, including silicon photo-multipliers (SiPM), single-photon avalanche diodes (SPAD), complementary metal-oxide-semiconductors (CMOS) or charge-coupled devices (CCD). In some embodiments, the imaging sensor may comprise of the order of 100 rows and of the order of 100 columns of sensing elements (for example SPADS). The imaging system may comprise other numbers of sensing elements (for example SPADS). For example, around 200×200 sensing elements, around 300×200 sensing elements, around 600×500 sensing elements, or other numbers of sensing elements, may be used. The optics of the imaging system 112 may be focusing optics which are arranged to form an image of the field of view 115 in a plane of the imaging sensor.

The imaging system 112 is operable to receive and detect a reflected portion 116 of at least some of the plurality of discrete light beams 114. The reflected portions 116 may, for example, be reflected from objects disposed in the field of view 115. In this document, “reflected” light includes light which is scattered towards the imaging system.

The focusing optics of the imaging system 112 form an image of the field of view 115 in a plane of the imaging sensor of the imaging system. The two-dimensional array of sensing elements divides the field of view 115 into a plurality of pixels (which may be referred to as sensing elements), each pixel corresponding to a different solid angle element. The focusing optics are arranged to focus light 116 received from each solid angle element onto a different pixel of the imaging system 112.

The controller 113 is operable to control operation of the projection system 110 and the imaging system 112. For example, the controller 113 is operable to send a control signal to the projection system 110 to control emission of light 114 from the projection system. Similarly, the controller 113 is operable to exchange signals with the imaging system 112. The signals may include control signals to the imaging system 112 to control activation of sensing elements within the imaging sensor of the imaging system. Intensity and timing information from the imaging sensor of the imaging system 112 may be transferred to the controller 113 (and/or to the processor 104).

The controller 113 may comprise any suitable processor which may be configured to process intensity information received from the imaging system 112. The controller 113 may be operable to calculate a range (i.e., distance) of an object within the field of view 115 from which each reflected portion 116 was reflected, based on time-of-flight (i.e., elapsed time between light being emitted from the projection system 110 and received at the imaging system 112-see further below). The controller 113 may be operable to identify a corresponding one of the plurality of discrete light beams 114 from which each reflected portion 116 originated. Using this information, the controller 108 may be operable to generate a depth map comprising a plurality of points, each point having: a depth value corresponding to a calculated range for a detected reflected portion 116 of a discrete light beam 114; and a position within the depth map corresponding to a position of the identified light beam 114 in the field of view 115.

In the time-of-flight measurement, the discrete light beams 114 are pulses of light emitted from the projection system 110. The time elapsed between the emission of a pulse and detection of the pulse by the imaging system 112 is the time-of-flight. The time-of-flight can be used to calculate the distance travelled by the pulses of light.

In the system 108 depicted in FIG. 1, reflected beams of light 116 (received as pulses of light) are detected as discrete areas of light on the imaging sensor of the imaging system 112. In this document discrete areas of light may be referred to as dots of light (or merely as dots). The time-of-flight for each dot detected by the imaging system 112 may be used to construct a depth map of the field of view 115 of the system 108.

A problem which arises when generating the depth map is that the spatial positions of the dots in the field of view 115 will change depending upon the distance from the system. The is due to parallax arising from the fact that the projection system 110 and imaging system 112 do not lie on the same axis (instead the projection system is located adjacent to the imaging system). The separation between the projection system 110 and the imaging system 112 will be different for each smartphone 100 due to manufacturing tolerances. As a result, the size of the parallax and its effect upon the dot array in the field of view 115, as detected by the imaging system 112, will be different for different smartphones 100. This may cause unwanted distortion of a depth map generated using the system 108. Embodiments of the invention address this issue.

In a calibration method according to an embodiment of the invention, the projection system 110 is used to project an array of discrete light beams 114 onto a wall 120 or another planar surface. Before this is done, a calibration pattern is provided on the wall 120. An example of a calibration pattern which may be used is depicted in FIG. 2. In this example, the calibration pattern 200 comprises an array of squares, each of which is provided with a different internal shape or pattern. In addition, corners of each square of the array are connected by smaller squares. Other calibration patterns may be used, for example a chessboard pattern, ChArUco pattern, circle grid, etc. The imaging system 112 is used to obtain an image of the calibration pattern 200. The calibration pattern may be provided on the wall by printing the calibration pattern and then fixing the printed calibration pattern onto the front of the wall. The printed calibration pattern may then be removed for subsequent steps of the method. Alternatively, the calibration pattern may remain in place but may be illuminated such that it is visible when being used but not visible when not being used. For example, the calibration pattern may be provided on a translucent layer (e.g. paper) which is provided on the wall (which may be transparent). A blank side of the translucent layer faces the depth map generating system 108. When the calibration pattern is being used, light is shone on the patterned side of the translucent layer, and as a result the calibration pattern is visible to the depth map generating system. When the calibration pattern is not being used, light is not shone on the patterned side of the translucent layer, and as a result the calibration pattern is not visible to the depth map generating system.

Intrinsic properties of the imaging system 112 are already known (as discussed further below). The intrinsic properties may comprise focal length, principal point, and distortion of the imaging system 112. Since the calibration pattern 200 is known and the intrinsic properties of the imaging system 112 are known, these can be used together with the sensed image of the calibration pattern 200 to calculate the position of the wall 120 relative to the imaging system 112. Specifically, a three-dimensional plane may be fitted to the sensed calibration pattern, and this plane may be recorded as being the plane of the wall 120. Calculating the position of the wall 120 may be performed by the controller 113. Once the plane of the wall 120 has been calculated, the projected calibration pattern may be removed from the wall (the projection system projecting the calibration pattern may be switched off).

Other methods may be used to determine the plane of the wall (or other planar surface). These methods may not need a calibration pattern. For example, a laser distance measuring tool may be used to determine the plane of the wall. Alternatively, the smartphone may be positioned at a predetermined distance and orientation from the wall. In one example the smartphone may be located on a conveyor belt, or other moving system, which is configured to move the smartphone to positions at predetermined distances from the wall (or other planar surface). These methods may provide a lower accuracy, but the accuracy may be sufficient for the calibration.

The projection system 110 is used to project an array of discrete light beams 114 which form an array of dots of light on the wall 120. This may be referred to as a dot pattern. The imaging system 112 captures an image of the dot pattern. In this way, a first array of dots on a planar surface (e.g. wall 120) located at a known distance from the projection system 110 is obtained by the imaging system 112.

The fitted plane of the wall 120 is used to calculate a set of three-dimensional positions of the projected dots (i.e. the three-dimensional positions of the dots on the wall 120).

In a first step of this calculation, for each pixel which makes up the image as captured by the imaging system 112, a ray is calculated. The ray is calculated using the known intrinsic properties of the imaging system. The ray intersects with the fitted plane of the wall 120. The three-dimensional position of the point at which the ray intersects with the plane of the wall is calculated and is recorded for that pixel. This is repeated for other pixels of the imaging sensor of the imaging system 112. Thus, a three-dimensional position on the wall is calculated for each pixel.

In a second step, the image which has been captured by the imaging system 112 is analysed to calculate the two-dimensional pixel locations of dots (areas of light) of the image captured by the imaging system (i.e., the positions of the dots on the image sensor). The embodiment does this with a quadratic interpolation method (although other methods may be used). Initial approximate positions of the dots may be calculated using a variety of different methods. For example, a threshold intensity value may be applied and then subtracted from the image. Following this, local maxima may be taken as being approximate dot positions. Alternatively, contours may be applied to the image, with centers of mass of contours being taken as approximate dot positions. Following this initial approximate determination of the dot positions, quadratic interpolation is used to calculate a central point of each dot. That is, a quadratic curve is fitted to the intensity values of the pixels which make up each provisionally identified dot. This quadratic interpolation may provide a sub-pixel accuracy for the dot position. Using quadratic interpolation provides dot position accuracy which may be better than dot position accuracy calculated using other methods. An example of detected dots 300, including calculated centers of those dots is depicted in FIG. 3. Other methods may be used to calculate centers of dots, although the other methods may be less accurate than quadratic interpolation.

The three-dimensional position on the plane of the wall 120 of each pixel of the imaging system 112 image sensor is known, and the two-dimensional positions of the dots on the pixels of the image sensor are known. A three-dimensional array of dots on plane of the wall 120 is constructed using this information. In common with other calculations, this may be done by the controller 113.

The smartphone 100 is then moved so that it is at a different distance from the wall 120. The known calibration pattern and the intrinsic characteristics of the imaging system 112 are again used to fit a plane for the wall 120. A dot array is again projected onto the wall. A three-dimensional array of dots on plane of the wall 120 is again constructed.

In this way, two three-dimensional arrays of dots on two planes at different distances from the imaging system 112 are constructed. These are stored in a memory, which may form part of the controller 113. The two three-dimensional arrays of dots may be referred to as a first three-dimensional array of dots and a second three-dimensional array of dots. No relationship has yet been established between the dots of the first and second three-dimensional arrays.

An advantage of embodiments of the invention is that distances between the smartphone and the wall of e.g. around 6 m, which are needed by prior art calibration methods, are not required. Embodiments of the invention may use distances of less than 1 m (although larger distances may be used). In an example, the first and second distances between the smartphone 100 and the wall 120 (or other planar surface) may for example be 60 cm and 50 cm. In general, the separation between maximum and minimum distances used by the invention may be less than 1 m, may be less than 50 cm, and may be less than 20 cm. The separation between maximum and minimum distances used by the invention may for example be around 10 cm.

Referring to FIG. 4, an estimated position 400 of the center of the projection system 110 is determined. This estimated position may be obtained for example from design documents relating to the smartphone 100. The estimated position may for example be 10 mm from the imaging system 112 in a specific direction. An array of straight lines 416 is then plotted, each line passing through the estimated center of the projection system 110 and passing through the center of a dot 450 of the constructed first three-dimensional array of dots (which lie on a first plane 452). Each line is thus associated with a dot of the first three-dimensional array of dots.

Referring to FIG. 5, points at which these lines 416 intersect with the plane 454 of the second three-dimensional array of dots are calculated. These points are then compared with the positions of the constructed second three-dimensional array of dots 456. Each dot 456 in the second three-dimensional array is associated with the closest intersection of a line and the plane of the second three-dimensional array. In this way, each line is associated with a dot in the second three-dimensional array of dots. Each dot of the first three-dimensional array is thereby associated with a dot of the second three-dimensional array (via the line which passes through both dots).

In some instances, this nearest neighbour approach to associating dots in the second three-dimensional array with the lines may produce incorrect matches. For example, an expected dot may not be detected by the imagining sensor of the imaging system 112. In order to address this, incorrect matches can be determined by calculating the distance between the dot and the ray intersection with the plane 454 of the constructed second three-dimensional array. If this distance exceeds a threshold value then the dot may be rejected (the dot may be considered to be an outlier). Where this occurs, some lines which pass through the first three-dimensional array of dots may not be associated with a dot in the second three-dimensional array. However, the majority of lines will be associated with a dot in both the first and the second three-dimensional arrays of dots. The method may use this majority of dots without a significant reduction of the accuracy of the method.

A first three-dimensional array of dots (in a first plane) and a second three-dimensional array of dots (in a second plane) has been obtained, with dots of each of the arrays being associated with each other. The position of the center of the projection system 110 has been estimated, but is not known. The next part of the method calculates the position of the center of the projection system 110. Straight lines are constructed which pass through the centers of associated pairs of dots. These straight lines will converge at a point or area at the projection system 110. The lines may not perfectly intersect at a single location. Thus, least-squares fitting may be used to calculate a central intersection point of the lines. Outliers may be determined and eliminated (i.e. lines which are a predetermined threshold distance away from an initially calculated central point of the projection system may be determined and eliminated). Once outliers have been eliminated, the least-squares fitting may be used to again calculate the central intersection point (thereby providing a more accurate determination of the central intersection point). In some embodiments rejection of outliers may not be used (it may not be needed). The calculated central point of intersection is considered to be the optical center of the projection system 110. A fitting method other than least-squares fitting may be used.

Once the optical center 600 of the projection system 110 has been calculated, a set of reference dots may be constructed. The set of reference dots is constructed by projecting the first and second three-dimensional arrays of dots into a virtual image (as is schematically depicted by FIG. 6). The projection system 110 is considered to be a virtual camera. The focal length of this virtual camera is set to be the same as the focal length of the imaging system (e.g. around 3 mm, which may be expressed in terms of pixels, e.g. around 300 pixels). The virtual camera has a principal point in the centre and has no distortion. As depicted in FIG. 6, the first three-dimensional arrays of dots 450 is projected through this virtual camera, as illustrated by lines 614. The positions of dots of light in the image plane of the virtual camera are recorded. The same is then done for the second three-dimensional array of dots (and any other three-dimensional arrays of dots). This will form two (or three or more) dots in the image plane which are associated with each other. An average location is calculated for the associated dots. This is done for each pair (or set) of associated dots, thereby forming an array of dot locations in the image plane. The dot locations may be expressed as pixel locations. These dots may be referred to as reference dots.

The reference dots may be combined with knowledge of the intrinsic properties of the imaging system 112, to predict the spatial position of each dot of light for any distance of an object from the imaging sensor. The prediction may calculate lines which extend outwardly from the imaging sensor, for each dot (area of light) that will be incident upon the imaging sensor in use. The lines may be referred to as three-dimensional rays.

During subsequent use of the smartphone 100, the three-dimensional rays calculated via the calibration can be used when generating a depth map. As noted further above, to generate a depth map, pulses of light are emitted from emitters of the projection system 110. Each pulse of light may be thought of as a ray of light 114 and forms a dot when incident upon an object in the field of view 115. Light is reflected from objects in the field of view 115, and forms dots on the imaging sensor of the imaging system. Each dot on the imaging sensor has a time-of-flight associated with it. This may be used to calculate the distance of the object from which that dot was reflected. The three-dimensional ray for that dot, calculated using the calibration, is combined with the calculated object distance to calculate the three-dimensional position of the object from which that dot was reflected. The same calculation may be performed for all other dots of an array of dots formed on the image sensor of the imaging system 112. This allows a more accurate depth map to be formed (compared with at least some prior art methods).

In the system 108 depicted in FIG. 1, reflected beams of light 116 (received as pulses of light) are detected as discrete areas of light on the imaging system of the imaging system 112. In this document discrete areas of light may be referred to as dots. The time-of-flight for each dot detected by the imaging system 112 may be used to construct a depth map of the field of view 115 of the system 108.

In the described embodiment of the invention, measurements are performed for two different distances of the smartphone from the wall (or other planar surface). However, measurements may be performed for three or more distances. Where this is the case, dots from each of the measured planes may be associated with each other. This may improve the robustness with which the optical center of the projection system is determined and may improve the accuracy of the calibration. For example, the third distance may be between the first and second distances. Thus, the first distance may for example be 60 cm, the second distance may for example be 50 cm, and the third distance may for example be 55 cm. When a third distance is used, the separation between the first distance and the third distance may for example be 10 cm or less.

The intrinsic properties of the imaging system may be calculated as follows: a chessboard pattern, ChArUco pattern, circle grid, or other calibration pattern is provided and is illuminated with a flood projector. Different views of the pattern are captured using the imaging system. A non-linear least-squares projection error minimization method is then used to determine the intrinsic camera properties. As noted above, the intrinsic properties of the imaging system may comprise focal length, principal point, and distortion of the imaging system.

The intrinsic properties of the imaging system may be consistent between smartphones of the same design. Where this is the case, the intrinsic properties may be determined for one smartphone and then used for other smartphones of the same design. This approach may provide a lower accuracy, but the accuracy may be sufficient for the calibration.

Calculations used by a method according to an embodiment of the invention may be performed by the controller 108.

The imaging system may be a camera.

Although the depth map generating system has been described in a smartphone, in other embodiments the depth map generating system may be in a tablet computer or other device.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

It will be appreciated that aspects of the present invention can be implemented in any convenient way including by way of suitable hardware and/or software. For example, a device arranged to implement the invention may be created using appropriate hardware components. Alternatively, a programmable device may be programmed to implement embodiments of the disclosure. The invention therefore also provides suitable computer programs for implementing aspects of the invention. Such computer programs can be carried on suitable carrier media including tangible carrier media (e.g., hard disks, CD ROMs and so on) and intangible carrier media such as communications signals.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

### LIST OF REFERENCE NUMERALS

100—Smartphone
102—Display
10—Processor
106—Memory
108—Depth map generating system
110—Projection system
112—Imaging system
113—Controller
114—Discrete light beams
115—Field of view
116—Reflected portions of discrete light beams
200—Calibration pattern
300—Dots (areas of light) detected by imaging system
400—Estimated position of center of projection system
416—Straight lines from estimated centre to first constructed three dimensional array of dots
450—Dots of first constructed three dimensional array of dots
452—Plane of first constructed three dimensional array of dots
454—Plane of second constructed three dimensional array of dots
456—Dots of second constructed three dimensional array of dots
600—Calculated optical center of projection system
614—Projection of dots through virtual camera at projection system

1. A method of calibrating a depth map generating system comprising a projection system and an imaging system, the method comprising:
using the projection system to project an array of dots onto a planar surface located at a first known distance from the projection system, obtaining a first image of the projected dots using the imaging system, and determining a first set of three-dimensional positions of the projected dots at the planar surface;
using the projection system to project an array of dots onto a planar surface located at a second known distance from the projection system, obtaining a second image of the projected dots using the imaging system, and determining a second set of three-dimensional positions of the projected dots at the planar surface;
associating projected dots of the first set of three-dimensional positions with projected dots of the second set of three-dimensional positions that define lines, and using convergence of the lines to calculate a position of the center of the projection system; and
using the calculated center position of the projection system, together with the projected dots and intrinsic properties of the imaging system, to predict the spatial position of dots of light for different distances of an object from the imaging system.

2. The method of claim 1, wherein associating the projected dots of the first set of three-dimensional positions with the projected dots of the second set of three-dimensional positions comprises: calculating lines which extend from an estimated center of the projection system through the first set of three-dimensional positions of the projected dots, determining intersection points of these lines with the plane of the second set of three-dimensional positions of the projected dots, and associating the intersection points with the dots of the second set of the projected dots.

3. The method of claim 2, wherein a distance between an intersection point of a line and a dot of the second set of dots is calculated, and if that distance exceeds a threshold value then the dot is rejected and is not associated with a dot of the first set of dots.

4. The method of claim 1, wherein centers of dots of the first image of the projected dots are calculated using quadratic interpolation.

5. The method of claim 1, wherein calculating the position of the center of the projection system using the convergence of the lines includes using a least-squares fit.

6. The method of claim 1, wherein calculating the position of the center of the projection system using the convergence of the lines includes calculating the position of the center, determining outlier lines and then recalculating the position of the center without including the outlier lines.

7. The method of claim 1, wherein the method further comprises measuring intrinsic properties of the imaging system.

8. A method of generating a depth map comprising using a projection system and an imaging system which have been calibrated according to any preceding claim, determining time-of-flight for beams of light emitted from the projection system, and using calculated three-dimensional rays which extend from the imaging system outwards to allocate three-dimensional positions for dots of light based upon times of flight.

9. A depth map generating system comprising a projection system and an imaging system, and a controller, the controller being configured to:
cause the projection system to project an array of dots onto a planar surface located at a first known distance from the projection system, to obtain a first image of the projected dots using the imaging system, and to determine a first set of three-dimensional positions of the projected dots at the planar surface;
cause the projection system to project an array of dots onto a planar surface located at a second known distance from the projection system, to obtain a second image of the projected dots using the imaging system, and to determine a second set of three-dimensional positions of the projected dots at the planar surface;
associate projected dots of the first set of three-dimensional positions with projected dots of the second set of three-dimensional positions that define lines, and use convergence of the lines to calculate a position of the center of the projection system; and
using the calculated center position of the projection system, together with the projected dots and intrinsic properties of the imaging system, predict the spatial position of dots of light for different distances of an object from the imaging system.

10. The depth map generating system of claim 9, wherein associating the projected dots of the first set of three-dimensional positions with the projected dots of the second set of three-dimensional positions comprises: calculating lines which extend from an estimated center of the projection system through the first set of three-dimensional positions of the projected dots, determining intersection points of these lines with the plane of the second set of three-dimensional positions of the projected dots, and associating the intersection points with the dots of the second set of the projected dots.

11. The depth map generating system of claim 10, wherein a distance between an intersection point of a line and a dot of the second set of dots is calculated, and if that distance exceeds a threshold value then the dot is rejected and is not associated with a dot of the first set of dots.

12. The depth map generating system of claim 9, wherein centers of dots of the first image of the projected dots are calculated using quadratic interpolation.

13. The depth map generating system of claim 9, wherein calculating the position of the center of the projection system using the convergence of the lines includes using a least-squares fit.

14. The depth map generating system of claim 9, wherein calculating the position of the center of the projection system using the convergence of the lines includes calculating the position of the center, determining outlier lines and then recalculating the position of the center without including the outlier lines.

15. The depth map generating system of claim 9, wherein intrinsic properties of the imaging system are stored in a memory.

16. The depth map generating system of claim 9, wherein the controller is further configured to determine time-of-flight for beams of light emitted from the projection system, and using calculated three-dimensional rays which extend from the imaging system outwards to allocate three-dimensional positions for dots of light based upon times of flight.
